(19) United States
(12) Patent Application Publication
(10) Pub. No.: US 2018/0155846 A1
(43) Pub. Date: Jun. 7, 2018

(54) Magnesium Alloy Substrate

(71) Applicant: HEWLETT-PACKARD DEVELOPMENT COMPANY, L.P., HOUSTON, TX (US)

(72) Inventors: CHI HAO CHANG, TAIPEI CITY (TW); KUAN-TING WU, TAIPEI CITY (TW); CHEN-TING LIN, TAIPEI CITY (TW)

(21) Appl. No.: 15/565,485

(22) PCT Filed: Jul. 28, 2015
(86) PCT No.: PCT/US2015/042460

§ 371 Date: Feb. 2, 2017

(51) Int. Cl. C25D 5/48; B05D 3/06; B05D 3/02; B05D 7/14; C25D 3/02

(52) U.S. Cl. CPC C25D 5/48; B05D 3/067; C25D 3/02; B05D 7/14; B05D 3/0254

(57) ABSTRACT

According to one example, forming a deposition layer on a magnesium alloy substrate and forming a cured coating on the deposition layer, where the cured coating is cured by ultra-violet radiation, heat at a cure temperature in a range from 60° C. to 140° C., or combinations thereof.

Examples of electronic devices include laptop computers, tablets, media players, and cellular telephones, among others. Electronic devices are becoming increasingly more sophisticated, powerful and user friendly. Various electronic devices can have differing characteristics.

### BRIEF DESCRIPTION OF THE FIGURES

FIG. 1 illustrates a block diagram of an example of a method according to the present disclosure.

FIG. 2 illustrates a block diagram of examples of a processing resource, a memory resource, and a computer-readable medium according to the present disclosure.

FIG. 3 illustrates a portion of a substrate for an electronic device in accordance with one or more examples of the present disclosure.

### DETAILED DESCRIPTION

Examples of the present disclosure provide substrates for an electronic device and methods for preparing the substrates. Examples of electronic devices include laptop computers, tablets, media players, and cellular telephones, among others. A substrate, which may be referred to as a housing among other terms, may be utilized to support and/or house a number of components of the electronic device.

As mentioned, examples of the present disclosure provide substrates for an electronic device and methods for preparing the substrate. Some previous coated substrates have been formed with processes, such as electrophoretic deposition, that can result in in a coating having bubbles. These bubbles may reduce the smoothness of the coating and may provide an undesirable texture for the substrate. The methods for preparing the substrates disclosed herein can help to provide substrates having desirable characteristics. For instance, the substrates disclosed herein may have a desirable mechanical property, such as hardness and/or a desirable tactile characteristic, such as smoothness. The methods for preparing the substrates disclosed herein may help provide a reduction of bubble formation, as compared to some previous coated substrates, and therefore may provide an improved smoothness.

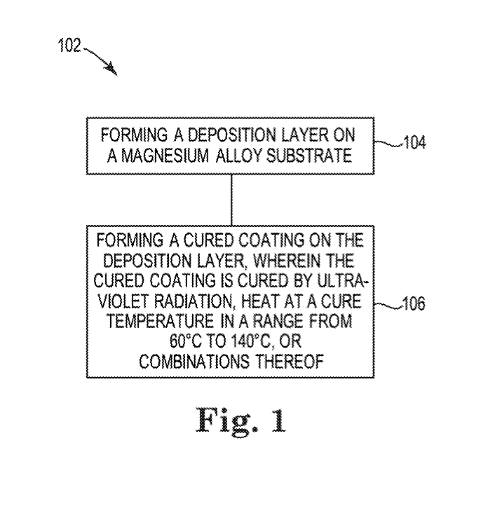

FIG. 1 illustrates a block diagram of an example of a method 102 according to the present disclosure. The method 102 may be utilized for preparing a substrate for an electronic device.

At 104, the method 102 can include forming a deposition layer on a magnesium alloy substrate. As mentioned, a substrate may be utilized to support and/or house a number of components of an electronic device. Some examples of the present disclosure provide that the substrate can be a magnesium alloy substrate. The magnesium alloy substrate can include magnesium, titanium, zinc, and an element selected from the group consisting of aluminum and lithium. Commercially available examples of magnesium alloys include AZ91, which includes magnesium, aluminum, and zinc, and LZ91, which includes magnesium, lithium, and zinc, among others.

Some examples of the present disclosure provide that a magnesium alloy may be cast to form a cast magnesium alloy substrate. For instance, the magnesium alloy may be sand cast or die cast to form the cast magnesium alloy substrate. For some applications, it may be preferable to die cast the magnesium alloy to form the cast magnesium alloy substrate.

Some examples of the present disclosure provide that the magnesium alloy substrate may be machined. For instance, the magnesium alloy substrate may be machined to accommodate various elements of an electronic device. An example of machining is computer numerical control machining. However, examples of the present disclosure are not so limited.

Some examples of the present disclosure provide that a magnesium alloy substrate can be surface treated. For instance, a magnesium alloy substrate, such as a cast magnesium alloy substrate that has been machined, may be surface treated prior to further preparation of the substrate. Examples of surface treatment include, but are not limited to cleaning and polishing. The surface treatment can be utilized to remove oxides, hydroxides, and/or excess lubricant from the magnesium alloy substrate, for example.

As mentioned, the method 102 can include 104 forming a deposition layer on a magnesium alloy substrate. The deposition layer, which may also be referred to as a coating among other terms, may be formed by electroplating, as discussed further herein. Some examples of the present disclosure provide that a layer, e.g., the deposition layer, is uniform on an exposed surface, such as the magnesium alloy substrate. However, as used herein, a “layer” may be un-uniform on the exposed surface. Additionally, a “layer” may not occur on all portions of the exposed surface. Such a partial layer is understood to be a layer herein.

The deposition layer can include various metals. The metals include aluminum, magnesium, lithium, zinc, chromium, nickel, titanium, niobium, stainless steel, copper, and alloys thereof, for example. Examples of the present disclosure provide that the deposition layer can have a thickness from about 3 μm (microns) to about 150 μm. Some examples of the present disclosure provide that the deposition layer can have a thickness from about 3.5 μm to about 100 μm.

As mentioned, examples of the present disclosure provide that the deposition layer can be formed by electroplating. Electroplating is a process where a number of deposition layers of a metal can be formed on the magnesium alloy substrate by passing a positively charged electrical current through an electroplating bath containing metal ions and a negatively charged electrical current through the magnesium alloy substrate. The electroplating bath may be a solution, e.g., an aqueous solution.

The electroplating bath may include precursors that are utilized to form the deposition layer on the magnesium alloy substrate. For instance, the deposition layer can include precursors, such as soluble metal salts among others that dissociate to metal ions in the electroplating bath. Different concentrations of precursors may be utilized for various applications. The metal ions can be deposited on the magnesium alloy substrate to form the deposition layer.

As mentioned, forming the deposition layer on the magnesium alloy substrate can include applying a current through the electroplating bath. Some examples of the present disclosure provide that a voltage from 3 volts to 100 volts is utilized. Some examples of the present disclosure provide that a voltage from 5 volts to 70 volts is utilized. Forming the deposition layer can occur at temperature of 0° C. to 80° C. Some examples of the present disclosure provide that forming the deposition layer can occur at temperature of 10° C. to 30° C.

At 106, the method 102 can include forming a cured coating on, e.g., in contact with, the deposition layer. Examples of the present disclosure provide that the cured coating is cured by ultra-violet radiation, heat at a cure temperature in a range from 60° C. to 140° C., or combinations thereof. As used herein, curing by ultra-violet radiation, heat at a cure temperature in a range from 60° C. to 140° C., or combinations thereof can be referred to a low temperature curing, in contrast to other curing processes that utilize temperatures greater than 140° C. Low temperature curing may help provide a desirable tactile characteristic, such as smoothness, for instance.

Some examples of the present disclosure provide that the cured coating is a thermoplastic. A thermoplastic is a material that becomes pliable and/or moldable above a specific temperature, e.g. a glass transition temperature of a thermoset, and solidifies upon cooling. Examples of thermoplastics include cyclic olefin copolymers, polymethylmethacrylate, polycarbonate, polyethylene, polypropylene, urethane acrylates, polystyrene, polyetheretherketone, polyesters, polyethylene terephthalate, polyvinyl chloride, polyvinylidene chloride, nylon, polysulfone, parylene, fluoropolymers and combinations thereof, among others.

Some examples of the present disclosure provide that the cured coating is a thermoset. A thermoset is a material that cures irreversibly into an infusible, insoluble polymer network. Examples of thermosets include materials having constitutional units including polyols, polycarboxylic acids, polyamines, polyamides, acetates, and combinations thereof, among others.

Precursors to the thermoplastic and/or the thermoset may be applied to the magnesium alloy substrate by various processes. For example, precursors to the thermoplastic and/or the thermoset may be applied by rolling, brushing, spraying, spinning, or dipping, among others.

Some examples of the present disclosure provide that the cured coating is formed by curing, via ultra-violet radiation. For instance, the cured coating can be an ultra-violet radiation cured thermoplastic or an ultra-violet radiation cured thermoset. The ultra-violet radiation may be provided from a variety of sources including, but not limited to, sunlight, mercury lamps, arc lamps, zenon lamps, and gallium lamps. Some examples of the present disclosure provide that ultra-violet radiation having wavelength from 10 nanometers (nm) to 450 nm may be utilized to form the cured coating. The ultra-violet radiation can have an intensity of 10 to 7,000 millijoules per square centimeter (mJ/cm²). The ultra-violet radiation can be applied to precursors, e.g., monomers and/or oligomers that are cured to form the cured coating, of the cured coating for an interval from 3 seconds to 10 minutes, for example, to form the cured coating.

Some examples of the present disclosure provide that precursors, e.g., monomers and/or oligomers, of the cured coating may be heat treated prior to and/or during exposure to the ultra-violet radiation. For instance, precursors of the cured coating may be heated to a temperature of 60° C. to 80° C. for an interval from 1 minute to 20 minutes prior to and/or during exposure to the ultra-violet radiation.

Some examples of the present disclosure provide that the cured coating may be formed from a ceramic-polymer composite. The cured coating, e.g., the ceramic-polymer composite, can be formed by curing precursors of the cured coating via heat at a cure temperature in a range from 60° C. to 140° C.

Some examples of the present disclosure provide that the cured coating, i.e. the ceramic-polymer composite, can be a sol-gel. Herein, the term “sol” refers to a dispersion of colloidal particles in a liquid, and the term “gel” refers to an interconnected network formed from the colloidal particles. The term “sol-gel” may refer to a sol and/or a gel. The sol can be converted into a gel, as mentioned above, by curing precursors of the cured coating via heat at a cure temperature in a range from 60° C. to 140° C.

The ceramic-polymer composite may be formed with an alkoxide. Examples of alkoxides include, but are not limited to, tetraethylorthosilicate, glycidoxypropyltriethoxysilane, 3-aminopropyltriethoxysilane, methacryloxypropyltrimethoxysilane, vinyltrimethylsiloxane, diphenyldimethoxysilane, zirconium isopropoxide, titanium ethoxide, zirconium ethoxide, niobium ethoxide, tantalum ethoxide, and combinations thereof, among others.

The ceramic-polymer composite may be formed with a polymer. Examples of polymers include, but are not limited to, polyacrylates, epoxies, acrylonitrile butadiene styrene, polycarbonates, polyurethanes, fluoro-polymers and combinations thereof, among others.

Such polymers can be formed via a polymerization reaction that includes corresponding polymerisable monomers, oligomers and/or elastomers. Examples of polymerization reactions include radical polymerization, non-radical polymerization, enzymatical polymerization, non-enzymatical polymerization, and poly-condensation, for instance.

Components of the polymerization reaction can be used to form a suspension, e.g., an emulsion or a dispersion. The suspension may be aqueous or non-aqueous; polar or non-polar. In addition to polymerisable monomers, oligomers and/or elastomers, the suspension may include various known polymerization reaction components, such as a surfactant, among others.

The alkoxide may be added to the components of the polymerization reaction before polymerization reaction has commenced and/or while the polymerization reaction is occurring. The alkoxide may be added to the components of the polymerization reaction as a solid and/or as a liquid. The alkoxide may be added to the components of the polymerization reaction as a suspension and/or solution.

The components of the polymerization reaction and/or the alkoxide can be applied to the magnesium alloy substrate by various processes. For example, some examples of the present disclosure provide that components of the polymerization reaction and/or the alkoxide can be applied to the magnesium alloy substrate via dipping, e.g., the magnesium alloy substrate may be dipped into a bath containing components of the polymerization reaction and the alkoxide.

In formation of the ceramic-polymer composite, e.g., curing precursors of the cured coating via heat at a cure temperature in a range from 60° C. to 140° C., the monomers, oligomers and/or elastomers may polymerize to form the polymer, while alkoxides, may hydrolyze to form a metal hydroxide species, which then via a condensation, may form the ceramic. The ceramic-polymer composite can include an interconnected network formed from the polymer and the ceramic. Some examples of the present disclosure provide that there may be a number of covalent bonds and/or a number of non-covalent bonds between the ceramic and the polymer.

Some examples of the present disclosure provide that the ceramic-polymer composite includes from 5 weight percent to 30 weight percent ceramic, based upon a combination of the ceramic and the polymer. For instance, the ceramic-polymer composite can include from 10 weight percent to 28 weight percent ceramic, or from 10 weight percent to 25 weight percent ceramic, based upon a combination of the ceramic and the polymer.

In various examples, the method can include forming a second cured coating. For instance, subsequent to forming a first cured coating, e.g., the ceramic-polymer composite as discussed herein, a second cured coating. e.g., that is cured by ultra-violet radiation as discussed herein, can be formed on the first cured coating. Forming the second cured coating on the first cured coating may provide a synergistic effect, such as an improved mechanical property, e.g., hardness, and an improved tactile characteristic. e.g., smoothness, as compared to other substrates, for the substrates as disclosed herein.

In various examples, the method can include forming a functional coating on the cured coating. Examples of the functional coating include, but are not limited to, anti-finger print coatings, anti-bacterial coatings, anti-smudge coatings, protection coatings, insulation coatings, and soft touch coatings. The functional coating can be formed by various processes. The functional coating can have different thicknesses for various applications.

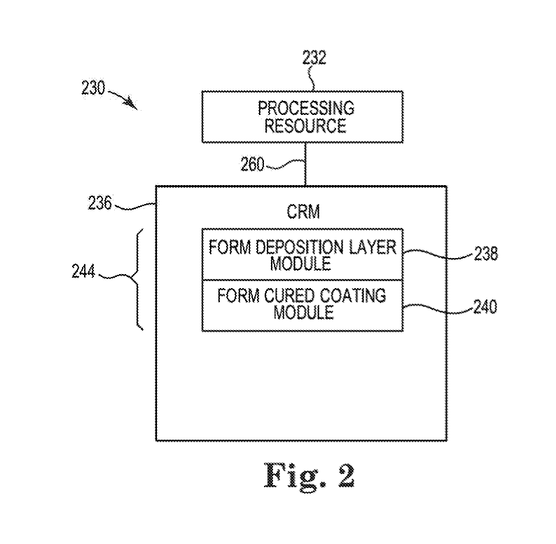

FIG. 2 illustrates a block diagram illustrating examples of a processing resource, a memory resource, and a computer-readable medium according to the present disclosure. The computing device 230 can utilize software, hardware, firmware, and/or logic to perform a number of functions. The hardware, for example can include a number of processing resources, e.g., processing resource 232, computer-readable medium (CRM) 236, etc. The program instructions, e.g., computer-readable instructions (CRI) 244, can include instructions stored on the CRM 236 and executable by the processing resource 232 to implement a desired function, such as form a deposition layer on a magnesium alloy substrate, and form a cured coating on the deposition layer, wherein the cured coating is cured by ultra-violet radiation, heat at a cure temperature in a range from 60° C. to 140° C., or combinations thereof, among others.

CRM 236 can be in communication with a number of processing resources other than processing resource 232. The processing resource 232 can be in communication with a tangible non-transitory CRM 236 storing a set of CRI 244 executable by one or more of processing resource, as described herein. The CRI 244 can also be stored in remote memory managed by a server and represent an installation package that can be downloaded. Installed, and executed.

Processing resource 232 can execute CRI 244 that can be stored on an internal or external non-transitory CRM 236. The processing resources 232 can execute CRI 244 to perform various functions, including the functions described herein, such as those discussed with FIG. 1, for instance.

The CRI 244 can include a number of modules, such as, for example, module 238 and module 240. Module 238 and module 240 in CRI 244 when executed by the processing resource 232 can perform a number of functions, as discussed herein.

Modules 238 and 240 can be sub-modules of other modules and/or contained within a single module. Furthermore, modules 238 and 240 can comprise individual modules separate and distinct from one another.

A form deposition layer module 238 can comprise CRI 244 and can be executed by the processing resource 232 to perform a function, e.g., forming a deposition layer on a magnesium alloy substrate, as discussed herein. The deposition layer can be formed by electroplating.

A cured coating module 240 can comprise CRI 244 and can be executed by the processing resource 232 to perform a function. e.g., forming a cured coating on the deposition layer. The cured coating module 240 can comprise CRI 244 and can be executed by the processing resource 232 to apply precursors of the cured coating to the magnesium alloy substrate, e.g., on the deposition layer. The cured coating module 240 can comprise CRI 244 and can be executed by the processing resource 232 to apply ultra-violet radiation, and/or heat at a cure temperature in a range from 60° C. to 140° C., or combinations thereof to form the cured coating.

In a number of examples, a form functional coating module (not pictured) can comprise CRI 244 and can be executed by the processing resource 232 to form a functional coating layer, as discussed herein, on the cast magnesium alloy substrate.

A non-transitory CRM 236, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 236 can be integral, or communicatively coupled, to a computing device, in a wired and/or a wireless manner. For example, the non-transitory CRM 236 can be an internal memory, a portable memory, a portable disk, or a memory associated with another computing resource, e.g., enabling CRIs 244 to be transferred and/or executed across a network such as the Internet.

The CRM 236 can be in communication with the processing resource 232 via a communication path 260. The communication path 260 can be local or remote to a machine, e.g., a computer, associated with the processing resource 232. Examples of a local communication path 260 can include an electronic bus internal to a machine, e.g., a computer, where the CRM 236 is one of volatile, non-volatile, fixed, and/or removable storage medium in communication with the processing resource 232 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 260 can be such that the CRM 236 is remote from processing resources, e.g., processing resource 232, such as in a network connection between the CRM 236 and the processing resource, e.g., processing resource 232. That is, the communication path 260 can be a network connection. Examples of such a network connection can include a local area network (LAN), wide area network (WAN), personal area network (PAN), and the Internet, among others. In such examples, the CRM 236 can be associated with a first computing device and the processing resource 232 can be associated with a second computing device. For example, a processing resource 232 can be in communication with a CRM 236, wherein the CRM 236 includes a set of instructions and wherein the processing resource 232 is designed to carry out the set of instructions.

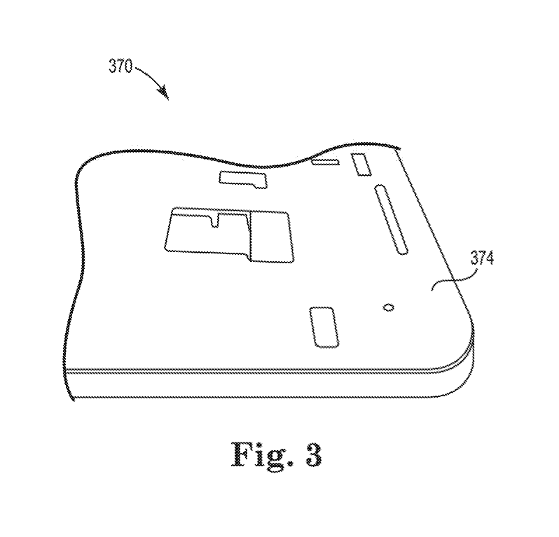

FIG. 3 illustrates a portion of a substrate 370 for an electronic device in accordance with one or more examples of the present disclosure. As discussed herein, the substrate 370 can be a magnesium alloy substrate, e.g. a cast magnesium alloy substrate. The substrate 370 can include various elements, such as magnesium, zinc, aluminum, and/or lithium, for instance. The substrates 370, as discussed herein, may have a desirable mechanical property, such as hardness and/or a desirable tactile characteristic, such as smoothness

The substrate 370 can have a deposition layer formed thereon. The deposition layer can be formed as previously discussed herein. For instance, the deposition layer can be formed by an electroplating process.

Subsequent to formation of the deposition layer, a cured coating 374 can be formed, as discussed herein. The cured coating 374 can be cured by ultra-violet radiation, heat at a cure temperature in a range from 60° C. to 140° C., or combinations thereof. Some examples of the present disclosure provide that a second cured coating, e.g., that is cured by ultra-violet radiation as discussed herein, can be formed on a first cured coating. e.g., the ceramic-polymer composite.

Some examples of the present disclosure provide that subsequent to formation of the cured coating, a functional coating can be formed on the substrate 370. Different functional coating layers may be utilized for various applications. The functional coating layer can be formed as the functional coating layers previously discussed herein.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software, firmware, etc., stored in memory and executable by a processor.

The specification examples are utilized to provide a description. Since many examples can be made without departing from the spirit and scope of the system and method of the present disclosure, this specification sets forth some of the many possible example configurations and implementations.

In the detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

The figures herein follow a numbering convention in which the first digit or digits correspond to the drawing figure number and the remaining digits identify an element or component in the drawing. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, “a number of” an entity, an element, and/or feature can refer to one or more of such entities, elements, and/or features.

What is claimed:

1. A method for preparing a substrate for an electronic device comprising:
forming a deposition layer on a magnesium alloy substrate; and
forming a cured coating on the deposition layer, wherein the cured coating is cured by ultra-violet radiation, heat at a cure temperature in a range from 60° C. to 140° C., or combinations thereof.

2. The method of claim 1, wherein forming the deposition layer on the magnesium alloy substrate comprises electroplating.

3. The method of claim 2, wherein the deposition layer comprises aluminum, magnesium, lithium, zinc, chromium, nickel, titanium, niobium, stainless steel, copper, or alloys thereof.

4. The method of claim 1, wherein forming the deposition layer on the magnesium alloy substrate includes forming the deposition layer to a thickness from about 3 μm to about 150 μm.

5. The method of claim 1, wherein forming the cured coating comprises forming an ultra-violet radiation cured thermoset or an ultra-violet radiation cured thermoplastic.

6. The method of claim 1, wherein forming the cured coating comprises forming a ceramic-polymer composite.

7. A non-transitory computer-readable medium storing a set of instructions for preparing a substrate for an electronic device executable by a processing resource to:
electroplate a deposition layer onto a magnesium alloy substrate;
form a curable coating on the deposition layer; and
cure the curable coating by ultra-violet radiation, heat at a cure temperature in a range from 60° C. to 140° C., or a combinations thereof.

8. The medium of claim 7, wherein the curable coating is cured to form a ceramic-polymer composite.

9. The medium of claim 8, further comprising instructions executable by a processing resource to form an ultra-violet radiation cured thermoset or an ultra-violet radiation cured thermoplastic on the ceramic-polymer composite.

10. The medium of claim 7, wherein the curable coating is cured to form an ultra-violet radiation cured thermoset or an ultra-violet radiation cured thermoplastic, and further comprising instructions executable by a processing resource to form a functional coating on the ultra-violet radiation cured thermoset or the ultra-violet radiation cured thermoplastic.

11. The medium of claim 10, wherein the functional coating is selected from the group consisting of an anti-finger print coating, an anti-bacterial coating, an anti-smudge coating, a protection coating, an insulation coating, and a soft touch coating.

12. A substrate for an electronic device comprising:
a cast magnesium alloy substrate including zinc and an element selected from the group consisting of aluminum and lithium,
wherein
a deposition layer is formed on the cast magnesium alloy substrate by electroplating; and
a cured coating is formed on the deposition layer, wherein the cured coating is cured by ultra-violet radiation, heat at a cure temperature in a range from 60° C. to 140° C., or combinations thereof.

13. The substrate of claim 12, wherein the cured coating is an ultra-violet radiation cured thermoset having constitutional units selected from the group consisting of polyols, polycarboxylic acids, polyamines, polyamides, acetates, and combinations thereof.

14. The substrate of claim 12, wherein the cured coating is an ultra-violet radiation cured thermoplastic selected from the group consisting of cyclic olefin copolymers, polymethylmethacrylate, polycarbonate, polyethylene, polypropylene, urethane acrylates, polystyrene, polyetheretherketone, polyesters, polyethylene terephthalate, polyvinyl chloride, polyvinylidene chloride, nylon, polysulfone, parylene, fluoropolymers and combinations thereof.

15. The substrate of claim 12, wherein the cured coating is a ceramic-polymer composite.
